(19) United States
(12) Patent Application Publication
(10) Pub. No.: US 2006/0130104 A1
(43) Pub. Date: Jun. 15, 2006

(54) Network video method

(76) Inventor: Madhukar Budagavi, Dallas, TX (US)

Correspondence Address: TEXAS INSTRUMENTS INCORPORATED, P O BOX 655474, M/S 3999, DALLAS, TX, 75265, US

(21) Appl. No.: 09/896,386

(22) Filed: Jun. 29, 2001

Related U.S. Application Data
(60) Provisional application No. 60/214,457, filed on Jun. 28, 2000.

(51) Int. Cl. H04N 7/173; H04N 7/12; H04B 1/66; H04N 11/04; H04N 11/02

(52) U.S. Cl. 725/105; 375/240.12; 375/240.27

(57) ABSTRACT

Motion compensation of real-time video for transmission over a packetized network is controlled by maximization of the probability of correct frame reconstruction according to a Markov model of packet transmission losses. The control determines a tradeoff of the intra-coded frame rate with a repeated predictively-coded frame rate.

### CROSS-REFERENCE TO RELATED APPLICATIONS

This application claims priority from provisional application Ser. No. 60/214,457, filed Jun. 30, 2000.

### BACKGROUND OF THE INVENTION

The invention relates to electronic devices, and more particularly to video coding, transmission, and decoding/synthesis methods and circuitry.

The performance of real-time digital video systems using network transmission, such as the mobile video conferencing, has become increasingly important with current and foreseeable digital communications. Both dedicated channel and packetized-over-network transmissions benefit from compression of video signals. The widely-used motion compensation compression of video of H.263 and MPEG uses I-frames (intra frames) which are separately coded and P-frames (predicted frames) which are coded as motion vectors for macroblocks of a prior frame plus the residual difference between the motion-vector-predicted macroblocks and the actual.

Real-time video transmission over the Internet is usually done using the Real-time Transport Protocol (RTP). RTP sits on top of the User Datagram Protocol (UDP). The UDP is an unreliable protocol which does not guarantee the delivery of all the transmitted packets. Packet loss has an adverse impact on the quality of the video reconstructed at the receiver. Hence, error resilience techniques have to be adopted to mitigate the effect of packet losses. A common heuristic technique used is the frequent periodic transmission of I-frames in order to stop the propagation of errors by P-frames. That is, the motion compensation is adjusted to increase the number of I-frames and correspondingly decrease the number of P-frames.

However, this reduces the transmission rate because I-frame encoding requires many more bits than P-frame encoding.

### SUMMARY OF THE INVENTION

The present invention provides a method of motion compensated video for transmission over a packetized network which trades off repeated transmission of a P-frames and the I-frame rate.

This has advantages including improved performance.

### BRIEF DESCRIPTION OF THE DRAWINGS

FIG. 1 illustrates a preferred embodiment Markov chain model.

FIG. 2 is a functional block diagram of a preferred embodiment encoder.

FIGS. 3a-3d and 4a-4d show experimental results.

FIG. 5 illustrates a system.

### DETAILED DESCRIPTION OF THE PREFERRED EMBODIMENTS

1. Overview

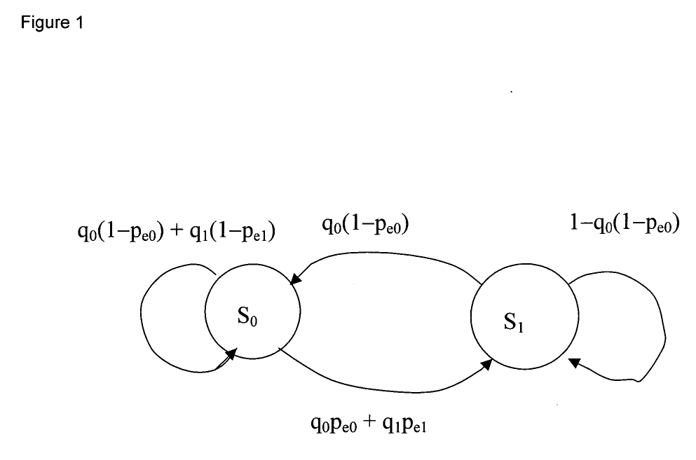

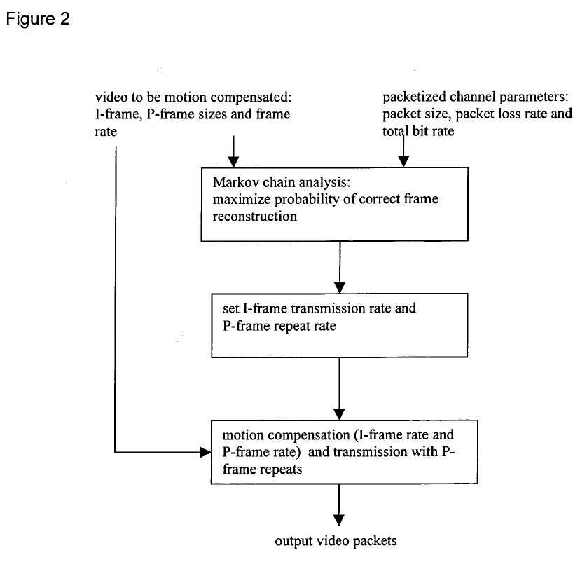

Preferred embodiment encoders and methods for motion compensated video transmission over a packetized network are illustrated generally in functional block form in FIG. 2. The preferred embodiments apply a Markov chain model (illustrated in FIG. 1) to control motion compensation compression by determining the rate of I-frames: a lower I-frame rate allows for repeated transmissions of P-frames as a forward error correction (FEC) method. This contrasts with the approach of increasing the I-frame rate and not repeating P-frames. In particular, the preferred embodiments maximize the probability of error-free reconstruction of frames as a function of the rate of I-frame transmission; a lower I-frame transmission rate allows for repeated transmissions of P-frames and thus increased probability of error free reception of P-frames.

2. First Preferred Embodiments

FIG. 1 shows a Markov model for a first preferred embodiment system having two states: S₀ the state when the current video frame reconstruction has no errors and S₁ the state when the current video frame reconstruction has at least one error. The probabilities are as follows: q₀ is the probability a transmitted frame is an I-frame and q₁=1−q₀ is the probability a transmitted frame is a P-frame; B-frames are ignored for this analysis. The probability a transmitted I-frame is lost is Pₑ₀ and the probability a transmitted P-frame is lost is Pₑ₁. Thus FIG. 1 shows remaining in state S₀ with probability q₀(1−pₑ₀)+q₁(1−pₑ₁) which simply is the probability that an I-frame was transmitted and not lost plus the probability that a P-frame was transmitted and not lost. Similarly, the system remains in state S₁ with probability 1−q₀(1−pₑ₀) which simply states that the only way to avoid a reconstruction error for a frame following an erroneous reconstructed frame is to receive (not lost) a transmitted I-frame because errors propagate in P-frames. Thus q₀(1−pₑ₀) also is the probability for transition from state S₁ to state S₀. Conversely, the probability of transition from state S₀ to state S₁ is just the probability of losing the next frame which is simply q₀pₑ₀+q₁Pₑ₁; that is, 1 minus the probability of remaining in state S₀. Thus the overall probability of being in state S₀ is q₀(1−pₑ₀)/(q₀+q₁pₑ₁) which is just the probability of an S₁ to S₀ transition divided by the sum of the probabilities of a state transition. Note that q₀ is equal to the reciprocal of the period (in frames) between I-frames; that is, if every nth frame is an I-frame, then the probability of a transmitted I-frame is 1/n.

Each transmitted packet over the Internet consists of compressed video data, an RTP header, and a UDP/IP header. Let v denote the number of bits in a packet header. For RTP/UDP/IP-based systems, v=320. Because of this huge packet overhead, it is better to transmit as many source bits as possible in a single packet. The total size of the packet is limited by the maximum transmission unit (MTU) of the packet network. For Ethernet, the MTU is about 1500 bytes. Current Internet video applications use relatively low bitrates; and at low bitrates multiple P-frames can be fit into a single packet. A problem with transmitting multiple P-frames in a single packet is that the effect of packet loss becomes very severe because loss of a single packet leads to the loss of multiple P-frames. Hence, only one P-frame is transmitted in a packet. With an MTU of 1500 bytes, I-frames, however, do not fit into a single packet and have to be split across multiple packets. For ease of description, let:

I₀ denote the average size of an I-frame expressed in bits.

I₁ denote the average size of a P-frame in bits.

n_{I} denote the number of packets required for a single I-frame.

k₀ denote the total number of bits (compressed bitstream plus header bits) used to transmit an I-frame, so k₀=I₀+n_{I}v where v is the packet header size in bits.

k₁ denote the total number of bits used to transmit a P-frame.

R_{T} denote the maximum transmission bit rate allowed.

q_{f1} denote the number of times each P-frame is retransmitted.

Presume a constant frame rate of f frames per second. Then the bit rate of the source, R_{S}, can be expressed as R_{S}=q₀fk₀+q₁fk₁ and the forward error correction bit rate, R_{F}, which adds q_{f1} retransmissions of each P-frame, is R_{F}=q₁q_{f1}fk₁ with q_{f1} nonnegative. Thus the total transmission rate, R, is R=R_{S}+R_{F}=q₀fk₀+q₁fk₁+q₁q_{f1}fk₁.

Let pₑ be the packet loss rate (assumed to be random) encountered on the Internet. Because only P-frames are retransmitted, the probability of loss of an I-frame is given by
pₑ₀=1−(1−pₑ)^{nI}
This just means that if any of the n_{I} packets containing a portion of an I-frame is lost, then the entire I-frame is lost. Similarly, the probability of loss of a P-frame is given by
pₑ₁=(1−m₁)pₑ^{└qf1┘+1}+m₁pₑ^{┌qf1┐+1}
where └q_{f1}┘is the largest integer not larger than q_{f1}, ┌q_{f1}┐ is the smallest integer not smaller than q_{f1}, and m₁ is the fractional part of q_{f1}, that is, m₁=q_{f1}−└q_{f1}┘. Heuristically, if q_{f1} were an integer, then the probability of losing all 1+q_{f1} packets containing a P-frame would be the probability of losing the P-frame and so pₑ₁=pₑ^{1+qf}. For noninteger q_{f1} the foregoing expression for pₑ₁ is just the linear interpolation between integer values bracketing q_{f1}.

The preferred embodiment FEC method then determines the rate of I-frame and repeated P-frame transmissions which maximizes the probability of being in state S₀ (=q₀(1−pₑ₀)/(q₀+q₁pₑ₁)) given the constraint that R≦R_{T}. Note that for a given probability of I-frame transmission, q₀, the value of q_{f1} immediately follows from taking the transmission rate R=q₀fk₀+q₁fk₁+q₁q_{f1}fk₁ equal to the maximum transmission rate, R_{T} because f, k₀, and k₁ are fixed parameters of the system and q₁=1−q₀. Further, note that periodic transmission of I-frames implies q₀ is of the form 1/n where n is the period in frames between two I-frames and is an integer. Thus just evaluate the constrained probability of being in state S₀ for all reasonable values of n and pick the q₀ which maximizes the probability.

3. Experimental Results

Two common test video sequences, “Akiyo”and “Mother and Daughter”, were used to evaluate the foregoing preferred embodiment method using the Markov model. The channel packet loss rate is assumed to be pₑ=10%. Whenever a frame or portion of a frame (in the case of an I-frame) is not received at the receiver, the evaluation simply copied the corresponding picture data from the previous frame. Note that because a large amount of data is lost with each packet loss, many of the more complicated error concealment techniques do not provide improved performance. The evaluation used two metrics: (i) average peak signal to noise ratio (PSNR) and (ii) fraction of frames reconstructed at the receiver that have a PSNR distortion of less than a threshold; the PSNR was obtained by averaging PSNR over 100 runs of transmitting the video bitstreams over a simulated packet loss channel, and the fraction of frames reconstructed for a distortion threshold t is denoted dₜ.

The maximum total bitrate, R_{T}, was taken to be about 50 kb/s; and the quantization parameter was taken to be 8 for compressing the video sequences. For both video sequences, q₀=⅙ results in a bitrate around 50-55 kb/s at f=10 frames/s; hence, the set of q₀s used was q₀=⅙, ⅛, . . . , 1/20. Note that the source bitrate decreases as qo decreases. In the range q₀=⅙ to 1/20, q₀=⅙ corresponds t the case of maximum rate of transmission of I-frames. For each of the video sequences, eight bitstreams were generated, one for each value of q₀. Frame lengths l₀ and l₁ used for the Markov chain analysis were obtained by averaging the I-frame and P-frame lengths, respectively, of the compressed bitstreams; and n_{I}=3 was used based on the I-frame size and MTU consideration.

For “Akiyo” the following list summarizes the parameters used for the Markov chain model:

pₑ=0.1

f=10 frames/s

average size of I-frame, I₀=20,475 bits

average size of P-frame, I₁=1,711 bits,

R_{T}=52.89 kb/s

n_{I}=3

q₀ in set ⅙, ⅛, . . . , 1/20

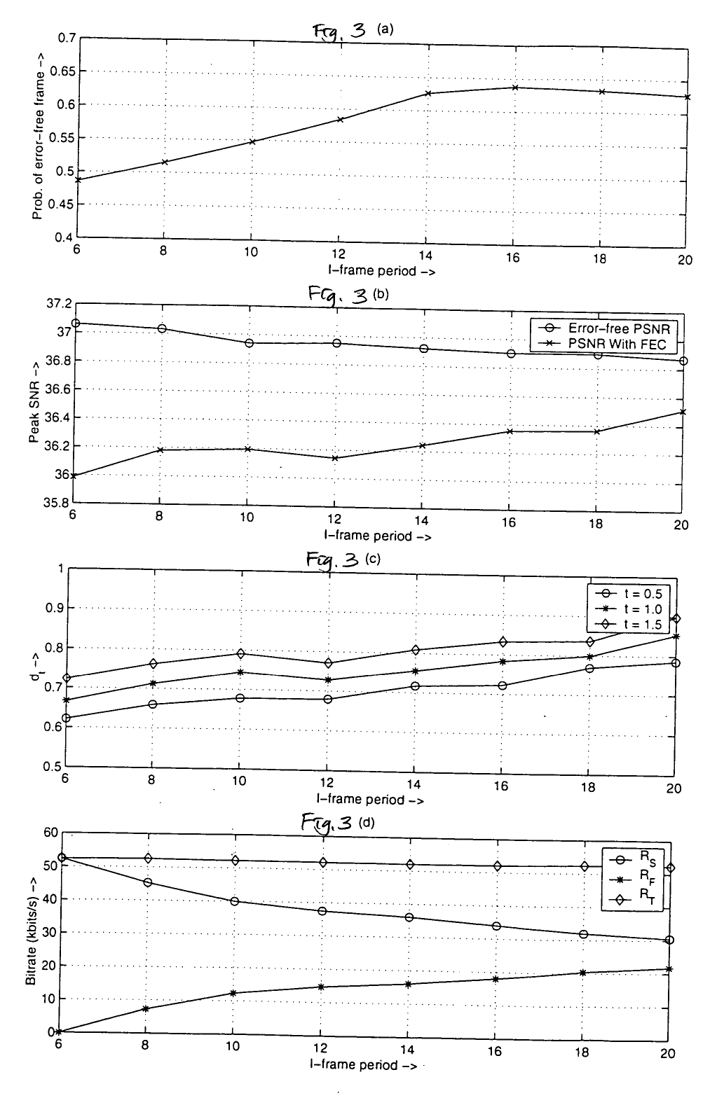

FIG. 3a shows the resulting Pr(S₀), the probability of being in state S₀, FIG. 3b shows the average PSNR for various values of q₀, and FIG. 3c shows the resulting fraction of reconstructed frames with distortion less than threshold, dₜ. To obtain FIGS. 3b and 3c, the P-frame retransmission rate, q_{f1}, derived from the Markov chain analysis was manually tweaked so that the total bitrate (source rate+FEC rate) was very near to the source bitrate (also the total bitrate) for q₀=⅙. This was done to provide a fair comparison of results. FIG. 3d shows the resulting total bitrate. In FIG. 3d R_{S} denotes the source rate, R_{F} denotes the rate used by the FEC, and R_{T} denotes the total bitrate.

As can be seen from FIG. 3a, the Markov chain model predicts that to obtain improved performance it makes sense to decrease the frequency of I-frames (from q₀= 1/6 to q₀= 1/14 . . . 1/20) and to instead use retransmission of P-frames. FIGS. 3b and 3c support this claim. There is an improvement in average PSNR in the range of 0.4-0.55 dB and fraction of reconstructed frames which have reconstruction errors less than t, with t=0.5, 1.0, 1.5 dB, goes up by about 0.15-0.2. The dₜ curve of FIG. 3c implies that there are about 20-25% more “good” frames when retransmission of P-frames is used instead of increasing the frequency of I-frame transmission.

For “Mother and Daughter” the following list summarizes the parameters used for the Markov chain model:

pₑ=0.1

f=10 frames/s

average size of I-frame, I₀=18,010 bits

average size of P-frame, I₁=2,467 bits,

R_{T}=54.84 kb/s

n_{I}=3

q₀ in set 1/6, 1/8, . . . , 1/20

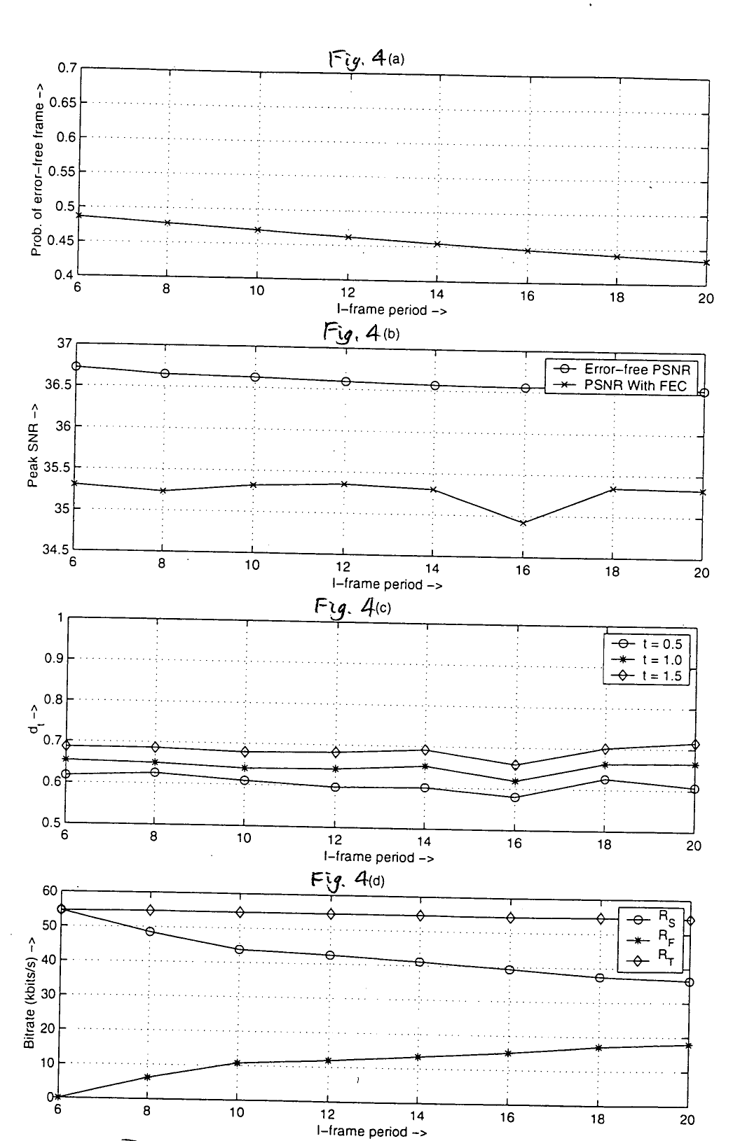

FIG. 4a shows the resulting Pr(S₀), FIG. 4b shows the average PSNR for various values of q₀, and FIG. 4c shows the resulting dₜ. To obtain FIGS. 4b and 4c, the P-frame retransmission rate, q_{f1}, derived from the Markov chain analysis again was manually tweaked so that the total bitrate was very near to the source bitrate (also the total bitrate) for q₀=⅙. This was done to provide a fair comparison of results. FIG. 4d shows the resulting total bitrate. In FIG. 4d R_{S} denotes the source rate, R_{F} denotes the rate used by the FEC, and R_{T} denotes the total bitrate.

The Markov chain analysis in this case predicts that a gain in performance cannot be achieved by decreasing the frequency of I-frames; see FIG. 4a. The PSNR and the dₜ curves of FIG. 4b and 4c support this claim. The PSNR and the dₜ curves remain more or less flat. Note that the PSNR and the dₜ curves do not move down like the Pr(S₀) curve of FIG. 4a. This can be attributed to the fact that the Markov chain model is a very simplistic model and is not based on the PSNR metric. More complex models can be thought of for modeling the PSNR performance, but they become complicated because of the use of motion compensation in the decoder.

4. System Preferred Embodiments

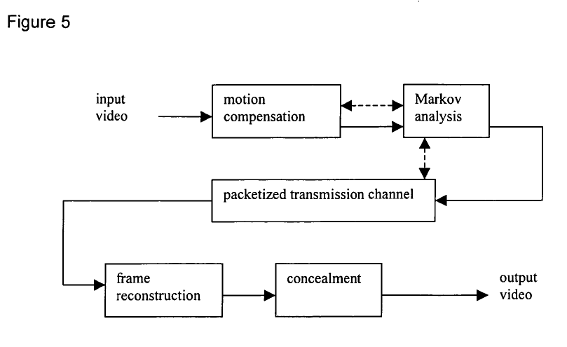

FIG. 5 shows in functional block form a portion of a preferred embodiment system which uses a preferred embodiment motion-compensated video transmission method. Such systems include video phone communication over the Internet with wireless links at the ends and voice packets interspersed with the video packets; a two-way communication version would have the structure of FIG. 5 for both directions. In preferred embodiment communication systems users (transmitters and/or receivers) hardware could include one or more digital signal processors (DSP's) and/or other programmable devices such as RISC processors with stored programs for performance of the signal processing of a preferred embodiment method. Alternatively, specialized circuitry (ASIC's) could be used with (partially) hardwired preferred embodiments methods. Users may also contain analog and/or mixed-signal integrated circuits for amplification or filtering of inputs to or outputs from a communications channel and for conversion between analog and digital. Such analog and digital circuits may be integrated on a single die. The stored programs, including codebooks, may, for example, be in ROM or flash EEPROM or FeRAM which is integrated with the processor or external to the processor. Antennas may be parts of receivers with multiple finger RAKE detectors for air interface to networks such as the Internet. Exemplary DSP cores could be in the TMS320C6xxx and TMS320C5xxx families from Texas Instruments.

5. Modifications

The preferred embodiments may be modified in various ways while retaining one or more of the features of optimization of I-frame rate in view of repeated P-frame transmission possibilities.

For example, the predictively-coded frames could include B-frames; the frame playout could include a large buffer and delay to allow from some automatic repeat request for I-frame packets to supersede some repeat P-frame packets; the network protocols could differ.

Indeed, one can introduce the concept of using multiple servers to serve the same video receiving client. For example, presume the use of two video servers to serve the same client. This situation has two network channels feeding into the video client. Use one channel to transmit the I-frame and P-frame (without repetition) and then use the other channel to transmit the FEC P-frames. Note that the rate of video received at the client is the same as when a single server is used. Use of two channels improves the performance, because the probability of both the channels deteriorating at the same time decreases.

What is claimed is

1. A method for motion compensation video, comprising:
(a) assessing parameters of a packetized transmission channel;
(b) assessing sizes of intra-coded frames and predictively-coded frames for an input video;
(c) setting the rate of intra-coded frames and the rate of predictively-coded frames by maximizing a probability of correct frame reconstruction using the results of steps (a) and (b), wherein said probability of correct frame reconstruction includes a rate of repeated transmission of predictively-coded frames.

2. The method of claim 1, wherein:
(a) said transmission channel is the Internet; and
(b) said predictively-coded frames are P-frames.

3. The method of claim 1, wherein:
(a) said parameters of step (a) of claim 1 include the packet loss rate over said transmission channel.

4. The method of claim 3, wherein:
(a) said probability is taken as q₀(1−pₑ₀)/(q₀+q₁pₑ₁) where q₀ is the probability of an intra-coded frame, q₁ is the probability of a predictively-coded frame, pₑ₀ is the probability of a transmitted intra-coded frame being lost, and pₑ₁ is the probability of a transmitted predictively-coded frame being lost.

5. A motion compensation controller for video, comprising:
(a) a first input for channel parameters of a packetized transmission channel;
(b) a second input for video parameters; and
(c) a probability maximizer coupled to said first and second inputs and with an output of an intra-coded frame transmission rate over said channel, a predictively-coded frame transmission rate over said channel, and a repetition rate for transmission of said predictively-coded frames over said channel; said probability maximizer maximizes a probability of correct frame reconstruction using said first and second inputs wherein said probability of correct frame reconstruction includes a rate of repeated transmission of predictively-coded frames.
